(19) United States
(12) Patent Application Publication
(10) Pub. No.: US 2016/0075100 A1
(43) Pub. Date: Mar. 17, 2016

(54) SLIPPING-RESISTANT MAT

(71) Applicant: Chun-Fu KUO, Taichung City (TW)

(72) Inventor: Chun-Fu KUO, Taichung City (TW)

(21) Appl. No.: 14/872,710

(22) Filed: Oct. 1, 2015

Related U.S. Application Data
(63) Continuation-in-part of application No. 14/485,635, filed on Sep. 12, 2014.

(51) Int. Cl. B32B 5/02; A47K 3/00; B32B 5/26; B32B 7/12

(52) U.S. Cl. CPC B32B 5/028; B32B 7/12; B32B 5/024; A47K 3/002; B32B 5/26; B32B 2255/26; B32B 2307/7265; B32B 2307/72; B32B 2307/744; B32B 2305/188; B32B 2255/02

(57) ABSTRACT

The slipping-resistant mat includes a top layer, a bottom layer, and a support layer. The top layer is formed with a plurality of top holes. The bottom layer is formed with weaved fibers. The bottom layer is formed with a plurality of bottom holes. The support layer in a predetermined thickness is formed with weaved fibers and arranged between the top layer and the bottom layer. The support layer is formed with a plurality of through holes. The top layer is arranged on a top of the support layer. The bottom layer is arranged on a bottom of the support layer. The top holes, the bottom holes, and the through holes communicate with each other. Each top hole has a smaller diameter than that of each bottom hole. The fibers of the bottom layer are at least partially covered with resin, PVC, PU, silicone, or rubber.

### BACKGROUND OF THE INVENTION

1. Field of the Invention

The present invention is a CIP of application Ser. No. 14/485,635, filed Sep. 12, 2014, the entire contents of which are hereby incorporated by reference.

2. Description of the Prior Art

A bathtub is usually used for shower or bath. No matter a user stands or sit in the bathtub, the wet bottom of the bathtub may make the user slip. Thus, an anti-slipping mat is usually placed on the bottom of the bathtub for the user to stand on or sit on.

Some mats are made of foam material. However, mats made of foam material have some disadvantages. First, the density of the foam mat is smaller than water, so the mat may float when the mat is drown by water. Second, the foam mat usually absorbs water. Thus, it is inconvenient that the water in the mat has to be squeezed out or discharged. In addition, the wet mat may easily become moldy. Besides, the mat which has absorbed water has less ability of anti-slip.

### SUMMARY OF THE INVENTION

The main object of the present invention is to provide a slipping-resistant mat which is ponding-preventing.

To achieve the above and other objects, the slipping-resistant mat of the present invention includes a top layer, a bottom layer, and a support layer in a predetermined thickness.

The top layer is formed with a plurality of top holes. The bottom layer is formed with weaved fibers. The bottom layer is formed with a plurality of bottom holes. The support layer in a predetermined thickness is formed with weaved fibers and arranged between the top layer and the bottom layer. The support layer is formed with a plurality of through holes. The top layer is arranged on a top of the support layer. The bottom layer is arranged on a bottom of the support layer. The top holes, the bottom holes, and the through holes communicate with each other. Each top hole has a smaller diameter than that of each bottom hole. The fibers of the bottom layer are at least partially covered with a coating agent selected from a group composed of resin, PVC, silicone, PU, and rubber.

Thereby, the slipping-resistant mat can prevent water from ponding therein for improving cleanliness.

The present invention will become more obvious from the following description when taken in connection with the accompanying drawings, which show, for purpose of illustrations only, the preferred embodiment(s) in accordance with the present invention.

### BRIEF DESCRIPTION OF THE DRAWINGS

FIG. 1 is a stereogram of the present invention;

FIG. 2 is a breakdown drawing of the present invention;

FIG. 3 is a cross-section drawing of the present invention;

FIG. 4 is a partial enlargement of FIG. 3;

FIG. 5 is an illustration of the present invention.

### DETAILED DESCRIPTION OF THE PREFERRED EMBODIMENTS

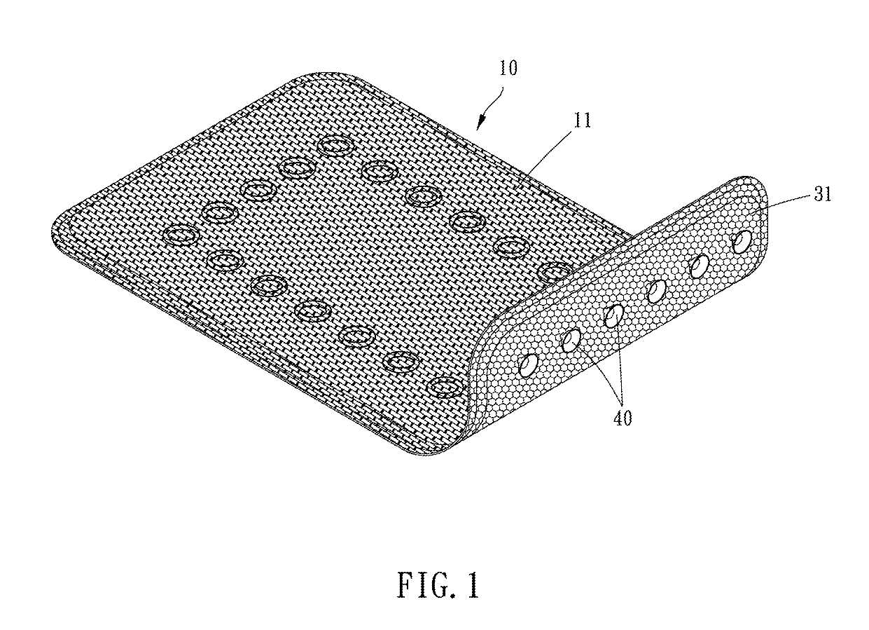

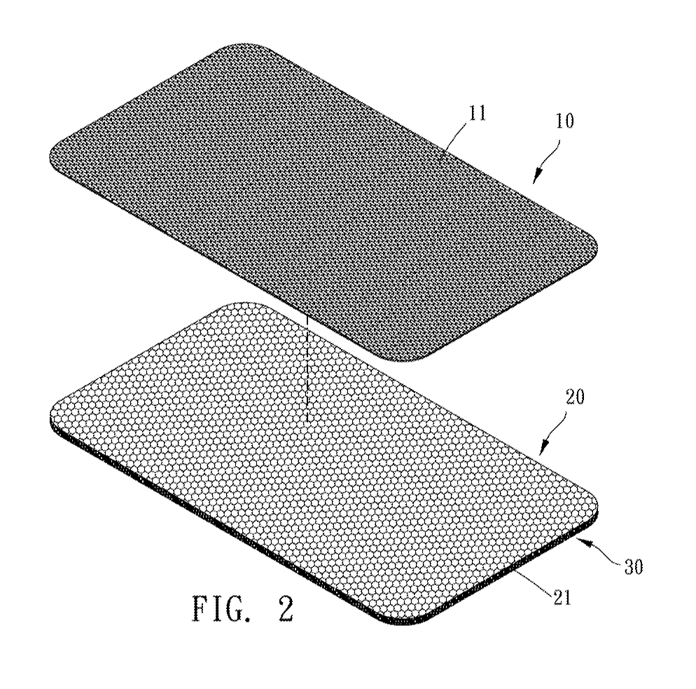

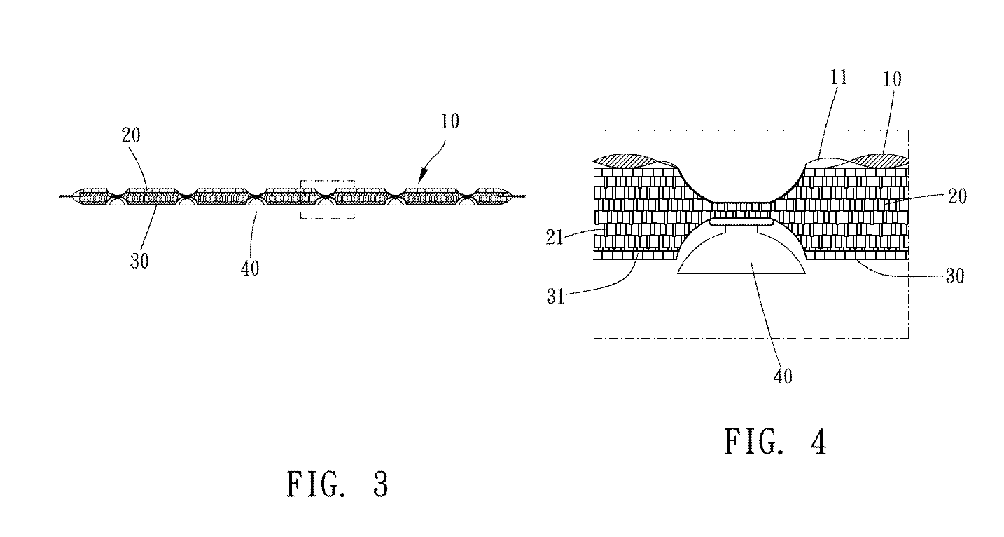

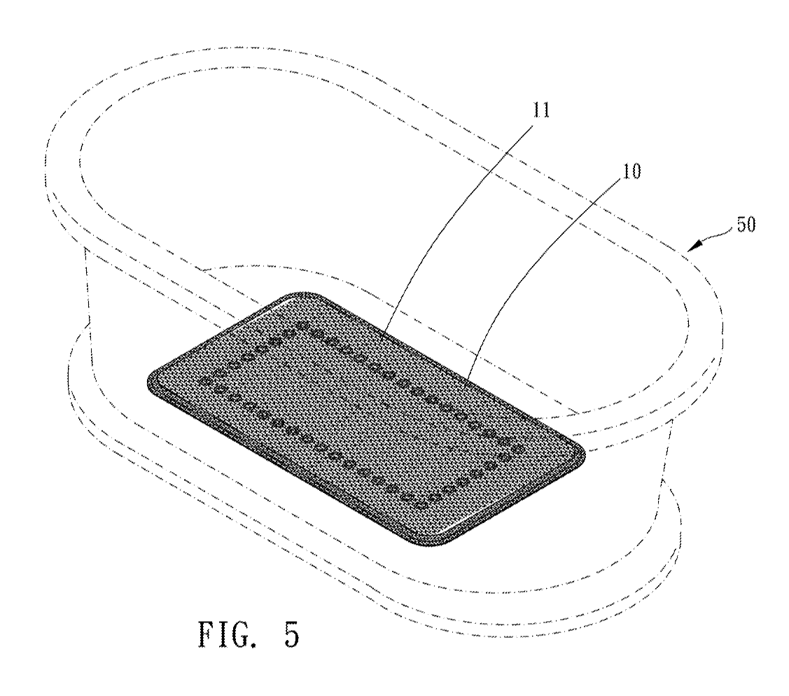

Please refer to FIG. 1 to FIG. 5, the slipping-resistant mat of the present invention includes a top layer 10, a bottom layer 30, and a support layer 20 in a predetermined thickness.

The top layer 10 is formed with a plurality of top holes 11. In the present embodiment, the top layer 10 is a mesh sheet formed with the top holes 11. The mesh sheet is at least partially covered or coated with resin, PVC, silicone, PU, or rubber and is foamed to be soft and slightly resilient. Preferably, the diameter of each top hole 11 is ranged between 0.1 cm to 1 cm.

The bottom layer 30 is made of weaved fibers, and the bottom layer 30 is formed with a plurality of bottom holes 31. The support layer 20 is also made of weaved fibers and is arranged between the top layer 10 and the bottom layer 30. The support layer 20 is formed with a plurality of through holes. The top layer 10 is arranged on the top of the support layer 20, and the bottom layer 30 is arranged on the bottom of the support layer 20. The top holes 11, the bottom holes 31, and the through holes 21 communicate with each other. Each top hole 11 has a diameter smaller than that of each bottom hole 31. The fibers of the bottom layer 30 are at least partially covered or coated with resin, PVC, silicone, PU, or rubber in order to improve waterproof and slipping-resistant effect, and to increase the density of the bottom layer. Besides, the mat of the present invention has a density designed to be larger than 1 gram per cubic centimeter so that the mat is able to sink into water when used in a bathtub.

In the present embodiment, fringes of the mesh sheet and the support layer 20 are engaged by melting, sewing, or resin. Optionally, the mesh sheet and the support layer can be fixed together by a positioning member, such as a frame. The support layer 20 and the bottom layer 30 are made of weaved fibers which are waterproof The thickness of the support layer 20 is ranged between 0.5 cm to 1.5 cm, and the thickness of the mesh sheet is smaller than that of the support layer 20. Besides, at least a part of the top holes 11 and the through holes 21 (even the bottom holes 31 too) are aligned non-coaxially. More specifically, the top holes are smaller than the bottom holes, and the number of the top holes is larger than the number of the bottom holes so that part of the top holes and the bottom holes are aligned non-coaxially. In addition, the material of the mesh sheet surrounding each top hole connects to and is engaged with the support layer.

The mesh sheet is independent from the support layer so that manufacturing is easier to achieve the goal that the top hole is smaller than the bottom hole. The smaller top holes ensure that dirt or dander may not fall into the mat. Also, standing water in the mat is prevented.

In other embodiments, the top layer, the support layer and the bottom layer can be weaved with a same fiber.

In use, the bottom layer 30 can be mounted (e.g. by thermocompression) with adhesion member 40, such as padsuckers, on the bottom thereof More specifically, the top layer, the support layer, the bottom layer, and the adhesion member are engaged together by thermocompression to provide some notches to receive the adhesion member. Thereby, the mat may not slide on the bottom of bathtub 50 or floor of bathroom. Besides, the density of the mat is designed to be larger than 1 gram per cubic centimeter so that the mat may not float on water.

In conclusion, the mat of the present invention is advantageous at the followings.

1. The present invention may not absorb water so that the mat is easy to dry and is free from mold.

2. The density of the mat is larger than 1 gram per cubic centimeter so that the mat may not float. In addition, the ability of anti-slipping is still provided.

3. The top holes are smaller than the bottom holes. Thus, water may be drained out fast.

4. The smaller top holes are able to keep scarf or hair from entering draining pipe.

5. The support layer provides better support and resilience so that the mat has excellent comfort.

6. The present invention is easy to be manufactured.

What is claimed is:

1. A slipping-resistant mat, including:
a top layer, formed with a plurality of top holes;
a bottom layer, formed with weaved fibers, the bottom layer formed with a plurality of bottom holes;
a support layer in a predetermined thickness, formed with weaved fibers and arranged between the top layer and the bottom layer, the support layer being formed with a plurality of through holes, the top layer being arranged on a top of the support layer, the bottom layer being arranged on a bottom of the support layer, the top holes, the bottom holes, and the through holes communicating with each other;
wherein each top hole has a smaller diameter than that of each bottom hole;
wherein the fibers of the bottom layer are at least partially covered with a coating agent.

2. The slipping-resistant mat of claim 1, wherein the coating agent is selected from a group composed of resin, PVC, silicone, PU, and rubber.

3. The slipping-resistant mat of claim 1, wherein the top layer, the support layer, and the bottom layer are made of a same weaved fiber.

4. The slipping-resistant mat of claim 1, wherein the top layer is a mesh sheet formed with the top holes.

5. The slipping-resistant mat of claim 4, wherein fringes of the mesh sheet and the support layer are engaged by melting.

6. The slipping-resistant mat of claim 4, wherein the mesh sheet and the support layer are fixed together by a positioning member.

7. The slipping-resistant mat of claim 4, wherein the mesh sheet is adhered onto the support layer by resin.

8. The slipping-resistant mat of claim 4, wherein the mesh sheet is at least partially covered with a coating agent selected from a group composed of resin, PVC, silicone, PU, and rubber.

9. The slipping-resistant mat of claim 8, wherein the coating agent is foamed.

10. The slipping-resistant mat of claim 1, wherein the support layer and the bottom layer are made of weaved waterproof fibers.

11. The slipping-resistant mat of claim 10, wherein a density thereof is larger than 1 gram per cubic centimeter.

12. The slipping-resistant mat of claim 4, wherein a thickness of the support layer is ranged between 0.5 cm to 1.5 cm, and a thickness of the mess sheet is smaller than the thickness of the support layer.

13. The slipping-resistant mat of claim 4, the diameter of each top hole is ranged between 0.1 cm to 1 cm.

14. The slipping-resistant mat of claim 4, wherein the top holes and the through holes are at least partially aligned non-coaxially.
